(19) United States
(12) Patent Application Publication
(10) Pub. No.: US 2025/0305310 A1
(43) Pub. Date: Oct. 2, 2025

(54) ANCHOR BRACKET FOR A SAFETY LINE

(71) Applicant: On Top Safety Equipment, LLC, Cheektowaga, NY (US)

(72) Inventors: John J. CARROCCIA, Orchard Park, NY (US); Jeffrey L. MURRAY, Hamburg, NY (US)

(21) Appl. No.: 18/873,057

(22) PCT Filed: Jun. 10, 2022
(86) PCT No.: PCT/US2022/072872

§ 371 Date: Dec. 9, 2024

(51) Int. Cl. E04G 21/32

(52) U.S. Cl. CPC E04G 21/328; E04G 21/329

(57) ABSTRACT

An anchoring bracket that secures a safety line includes a pair of anchoring plates, a ridge cap member, and at least one D-ring connector. Each of the anchoring plates is hingedly connected the ridge cap member on opposite sides thereof and the D-ring connection member is rotatably connected to a top side member of the ridge cap member. Each of the anchoring plates includes first and second leg members having a plurality of boreholes therethrough. The anchoring plates may be opened to be placed on a flat roof or over a roof peak and secured to one or more structural members of the roof, e.g., roof rafters, trusses, joists, or Z-purlins, as well as portions of the roof decking, using appropriate fasteners in accordance with one or more safety regulations or protocols, e.g., local, OSHA, ANSI.

### FIELD

The instant disclosure broadly relates to fall mitigation devices, more specifically to anchoring systems for securing a line, and even more specifically to an anchor bracket capable of securing a line so as to mitigate injury in the event of a fall from a height.

### BACKGROUND

Fall mitigation devices, fall arresting systems, as well as fall anchoring systems for preventing injury as a result of the fall from a height, such as a roof, are known. Such systems can range from very complex machines that are triggered upon the event of a fall so as to dampen the forces experienced by a falling worker, for example, as described in U.S. Pat. No. 10,183,185, to very simple anchoring brackets that can be readily fastened to the wood or metal frame of flat or peaked roofs.

An example of a so-called simple anchoring bracket 100 is shown in FIGS. 1A and 1B. A few common features of simple anchoring brackets as shown in FIGS. 1A and 1B are that they typically include a base member 110 formed of a pair of legs 120 each having a plurality of boreholes 150 for purposes of securing each leg 120 to the surface of a roof via common fasteners such as nails and screws. In most cases, the pair of legs 120 are secured to one another via a hinge formed by knuckles 130 of each leg 120 and hinge pin 140 in the form of a D-ring, which has a looped portion capable of securing a safety line. As may be appreciated from FIGS. 1A and 1B, boreholes 150 of each leg 120 generally extend along a direction that is parallel to the longitudinal axis of each leg 120 so as to form a plurality of longitudinally extending lines of boreholes. In the case of FIGS. 1A and 1B, for example, each leg 120 includes three longitudinally extending lines of boreholes. In accordance therewith and in accordance with various safety requirements (OSHA) and/or recommendations (ANSI), for example, when anchoring bracket 100 is secured to a wooden framed roof having a peak, each leg 120 can be spread apart from one another via the hinge and placed over the peak of the roof (or be placed flat in the case of flat roof) such that the boreholes associated with the center line are aligned with a rafter, truss, or joist of the wooden roof, or a purlin in the case of a metal roof. Once aligned with the rafter, truss, or joist, appropriate fasteners such as nails, screws, or combinations thereof may then be used to secure the bracket to the rafter, truss, or joist, or purlin. Boreholes 150 associated with the remaining outer lines of boreholes may then be utilized to further secure the anchor bracket 100 to the roof decking, e.g., plywood sheathing or metal sheeting, as set forth by various OSHA and/or ANSI requirements.

While anchoring bracket 100 is well suited for its intended purpose, there are a few drawbacks. One such drawback that because each leg is only securable to a single rafter, truss, or joist, in the case of re-shingling an existing roof, for example, where the condition of the rafters, trusses or joists may be unknown, if the anchoring bracket 100 is secured to a rotten, deteriorated, or unsuitable rafter, truss or joist, the anchoring bracket may not properly secure to the roof and may then break free when a force is applied. Another drawback is that because the anchoring bracket is limited to a pair of legs 120 secured to one another via a hinge including a D-ring, the movement of the D-ring is limited to the direction shown by the arrows, which has the effect of limiting the effective working range of the anchoring bracket to 30 degrees from plumb on each side due to the potential of injury resulting from swing falls. Finally, because legs 120 are primarily only secured to a single rafter, truss or joist along the longitudinal axis of the legs 120, if a lateral force is applied upon the anchoring bracket as a result of a fall, the anchoring bracket may more readily break free from the roof structure as compared to a force that is applied along the longitudinal axis.

Thus, there is a long-felt need for an anchoring bracket that is easy to secure to a roofing system, is more robust in that it is capable of being additionally secured to one or more members of a roofing system and less likely to break free from the roof structure, and increases the available effective working range.

### SUMMARY

At the outset it should be understood that while the following disclosure, figures, and/or claims, etc. describe subject matter including one or more aspects described as either alone or in combination with one or more other aspects, the subject matter of the instant disclosure is not intended to be so limited. That is, the instant disclosure, figures, and claims are intended to encompass the various aspects described herein, either alone or in one or more combinations with one another. For example, while the instant disclosure may describe and illustrate a first aspect, a second aspect, and a third aspect in a manner such that the first aspect is only specifically described and illustrated relative to the second aspect, or the second aspect is only described and illustrated relative to the third aspect, the instant disclosure and illustrations are not intended to be so limiting and may encompass the first aspect alone, the second aspect alone, the third aspect alone, or one or more combinations of the first, second, and/or third aspects, e.g., the first aspect and the second aspect, the first aspect and the third aspect, the second and third aspect, or the first, second and third aspects.

This instant disclosure is generally related to an anchoring bracket that secures a safety line that includes a pair of anchoring plates, a ridge cap member, and at least one D-ring connector. Each of the anchoring plates is hingedly connected the ridge cap member on opposite sides thereof and the D-ring connection member is rotatably connected to a top side member of the ridge cap member. Each of the anchoring plates includes first and second leg members having a plurality of boreholes therethrough. The anchoring plates may be opened to be placed on a flat roof or over a roof peak and secured to one or more structural members of the roof, e.g., roof rafters, trusses, joists, or purlins, as well as portions of the roof decking, using appropriate fasteners in accordance with one or more safety regulations or protocols, e.g., local requirements, OSHA requirements, or ANSI standards.

In some aspects, the anchoring bracket includes a pair of anchoring plates each including at least a first leg member extending in a first direction and at least a second leg member extending in a second direction perpendicular to the first direction such that the first leg member and the second leg member intersect with one another. In some aspects, each of the at least one first leg members includes a hinge knuckle at a terminal end thereof. In some aspects, the anchoring bracket includes a ridge cap member having a top member connecting a pair of opposite side members disposed at opposite angles to thereby form a peak. Each of the oppositely disposed side members include an aperture forming a hinge pin member that connects the hinge knuckle of a respective first leg member such that each of the pair of anchoring plates is pivotally secured to the ridge cap member on a respective opposite side member of the ridge cap member. In some aspects, a D-ring connector is rotatably connected to the top side member of the ridge cap member.

In some aspects, each of the first leg member and second leg member include at least a plurality of spaced apart boreholes disposed along a portion of a length or width of each of the first leg member and the second leg member. In some aspects, the plurality of boreholes disposed along the portion of the length or width of the first leg member and the second leg member are spaced apart from one another to form at least one line of boreholes. In some aspects, the plurality of boreholes disposed along the portion of the length or width of the first leg member and the second leg member are spaced apart from one another to form at least two lines of boreholes. In some aspects, the plurality of boreholes disposed along a portion of the length or width of the first leg member and the second leg member are spaced apart from one another to form at least three lines of boreholes. In some aspects, a portion of the plurality of boreholes forming the at least one line of boreholes are equidistantly spaced apart from one another. In some aspects, a first portion of the plurality of boreholes forming the at least one line of boreholes are equidistantly spaced apart from one another, and a second portion of the plurality of boreholes forming the at least one line of boreholes are not equidistantly spaced part from one another. In some aspects, the plurality of boreholes form at least a first line of boreholes and a second line of boreholes, and a portion of the plurality of boreholes of the first line are equidistantly spaced apart from one another, and a portion of the plurality of boreholes of the second line are equidistantly spaced apart from one another, and the portion of the line of boreholes associated with the first line are aligned relative to the portion of the line of boreholes associated with the second line along one of a length or width thereof. In some aspects, the plurality of boreholes form at least a first line of boreholes and a second line of boreholes, and a portion of the plurality of boreholes of the first line are equidistantly spaced apart from one another, and a portion of the plurality of boreholes of the second line are equidistantly spaced apart from one another, and the portion of the line of boreholes associated with the first line are offset relative to the portion of the line of boreholes associated with the second line along one of a length or width thereof.

In some aspects, each of the anchoring plates includes a third leg member extending in a second direction perpendicular to the first direction such that the first leg member and the third leg member intersect with one another. In some aspects, the third leg member includes a plurality of boreholes disposed along a portion of a length or width thereof to form at least one line of boreholes.

In some aspects, the second leg member of each anchoring plate is integral with the first leg member of each anchoring plate. In some aspects, the second leg member of each anchoring plate comprises a pair of second leg sub-members hingedly connected to the first leg member on opposite sides thereof. In some aspects, the second leg member of each anchoring plate comprises a pair of second leg sub-members rotatably connected to the first leg member. In some aspects, the second leg member of each anchoring plate is rotatably connected to the first leg member.

In some aspects, the top side member of the ridge cap member is disposed at a height relative to each of the apertures, and the D-ring connector is rotatably connected to the top side member with one or more of a nut, a bolt, a washer, a bearing, a washer bearing, and a rivet.

In some aspects including a plurality of D-ring connectors, each of the D-ring connectors is rotatable relative to the top side member and are rotatable relative to one another. In some aspects including a plurality of D-ring connectors, each of the plurality of the D-ring connectors are coaxially rotatably connected to the top side member with one or more of a nut, a bolt, a washer, a bearing, a washer bearing, and a rivet. In some aspects including a plurality of D-ring connectors, one of the plurality of D-ring connectors includes a flat top side member connecting portion and a raised bent portion, the raised bent portion being offset at a height relative to the flat top side member connecting portion. In some aspects including a plurality of coaxially disposed D-ring connectors, at least one or more of a washer or bearing is disposed between the plurality of D-ring members.

In some aspects including a plurality of coaxially disposed D-ring members, one or more stops may be included so as to limit the rotational range of motion of the respective D-ring connection members relative to one another.

In some aspects, the various components forming the anchoring bracket are made from appropriate materials and utilize appropriate fasteners in terms of qualities such as strength, corrosion resistance, etc., in accordance with local requirements, OSHA requirements, and ANSI standards, e.g., steel, stainless steel, aluminum, etc.

In some aspects, two or more anchoring brackets separated by a distance can be connected to one another with a line that serves as a safety line connection point for one or more users.

### BRIEF DESCRIPTION OF THE DRAWINGS

The nature and mode of operation of the inventive subject matter will now be more fully described in the following detailed description taken with the accompanying drawing figures, in which:

FIGS. 1A and 1B are perspective and side views, respectively, of a known anchoring bracket;

FIG. 2 is a perspective view of an anchoring bracket in accordance with the instant disclosure;

FIGS. 3A and 3B side and front elevation views, respectively, of an anchoring bracket in accordance with the instant disclosure;

FIG. 4 is a top view of an anchoring bracket in accordance with the instant disclosure;

FIG. 5 is a cross sectional view, taken along line 5-5 of FIG. 4, of an anchoring bracket in accordance with the instant disclosure;

FIG. 6 is an exploded view of an anchoring bracket in accordance with the instant disclosure;

FIG. 7 is a perspective view of an anchoring bracket in accordance with the instant disclosure showing a manner by which the anchoring bracket may be secured to a roof;

FIG. 8 is a perspective view of an anchoring bracket in accordance with the instant disclosure including a plurality of D-ring connectors rotatable relative to one another; and

FIGS. 9 and 10 are perspective views of anchoring brackets in accordance with the instant disclosure including rotatable and hinged leg member portions, respectively.

### DETAILED DESCRIPTION

At the outset, it should be appreciated that like drawing numbers and/or the use of prime notations on different drawing views are intended to identify identical, similar, or functionally similar, structural elements. It is to be understood that the claims are not limited to the specifically disclosed and illustrated aspects.

Furthermore, it is understood that this disclosure is not limited to the particular methodologies, materials and modifications described and as such may, of course, vary. It is also understood that the terminology used herein is for the purpose of describing particular aspects only and is not intended to limit the scope of the disclosure or claims.

Unless defined otherwise, all technical and scientific terms used herein have the same meaning as commonly understood to one of ordinary skill in the art to which this disclosure belongs. Although any methods, devices or materials similar or equivalent to those described herein can be used in the practice the example aspects.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of: ” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

It should be appreciated that the term “substantially” and “generally” are synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

By “non-rotatably connected” elements, it is meant that: the elements are connected so that whenever one of the elements rotate, all the elements rotate; and relative rotation between the elements is not possible. Radial and/or axial movement of non-rotatably connected elements with respect to each other is possible, but not required. Additionally, “plastic deformation” is intended to mean instances when a sufficient load is applied to a material that causes a permanent change in shape to that material.

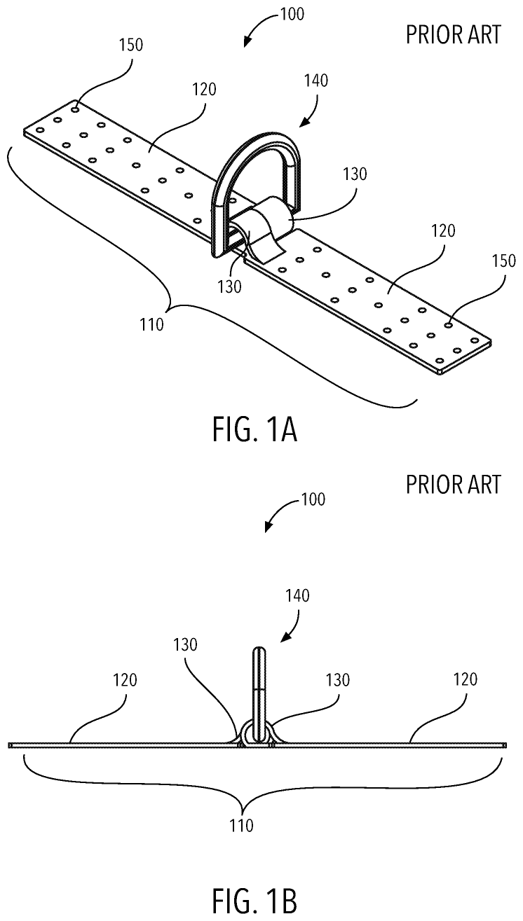

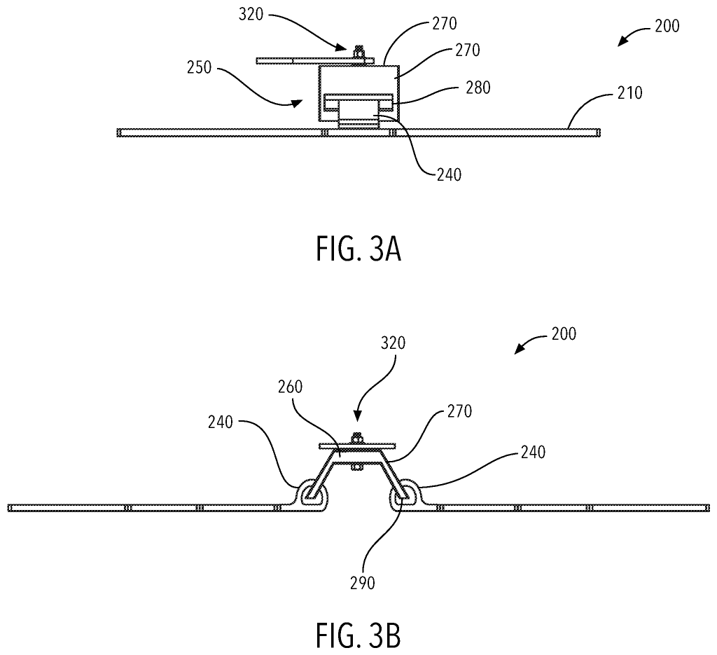

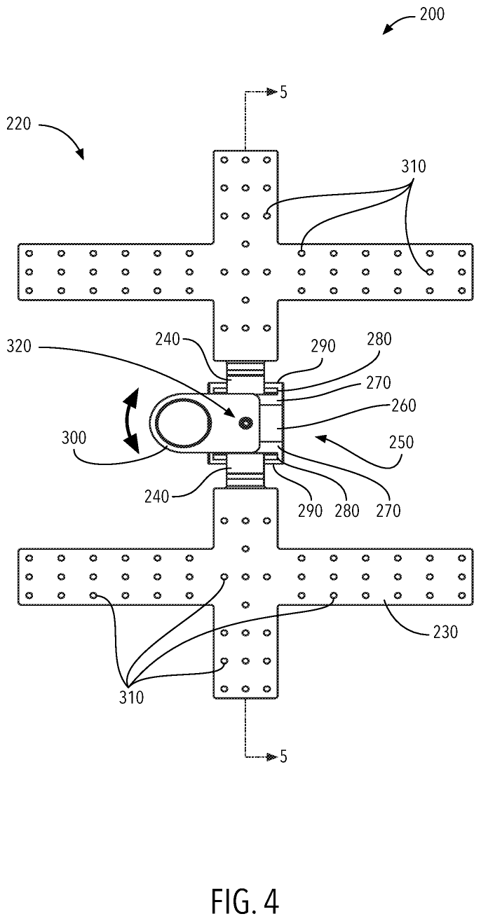

Adverting now to the figures, it should be appreciated that the figures depict various aspects of the inventive subject matter. Referring now to FIGS. 1-6, anchoring bracket 200 according to one or more aspects described and illustrated herein is shown as generally including anchoring plates 210, ridge cap member 250, and D-ring connector 300.

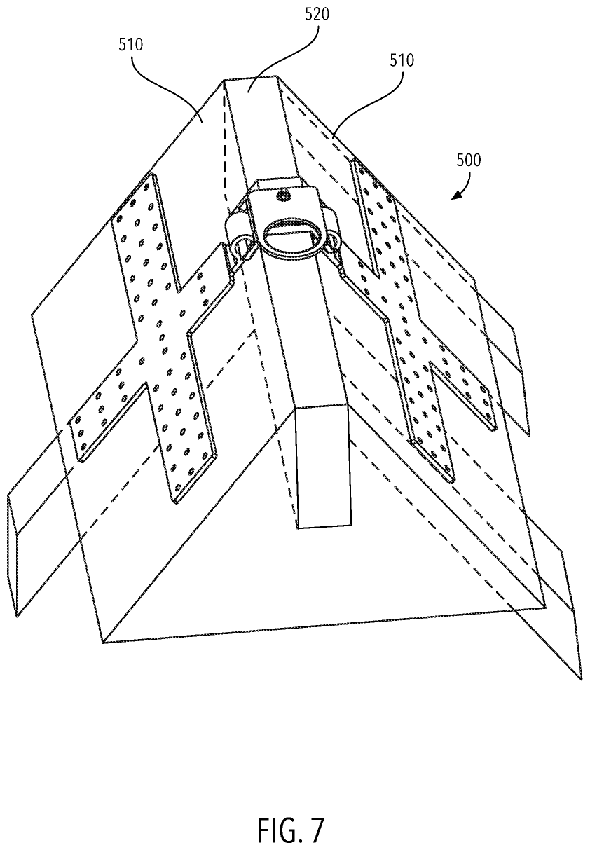

Each anchoring plate 210 includes at least a first leg member 220 extending in a first direction and at least a second leg member 230 extending in a second direction perpendicular to the first direction such that the first leg member 220 and the second leg member 230 intersect with one another. Each of the first leg members 220 includes a hinge knuckle 240 at a terminal end thereof that pivotally secures each of the anchoring plates 210 to hinge pin member 290 of ridge cap member 250. Each of the first leg member 220 and second leg member 230 include a plurality of spaced apart boreholes 310 disposed along a portion of a length and width of each of the first leg member 220 and the second leg member 230, which boreholes 310 are used to secure each anchoring plate 310 to a surface such as a roof 500 (See FIG. 7) using appropriate fasteners such as nails, screws or combinations thereof (not shown), i.e., as required by local regulations, OSHA regulations, or ANSI standards.

In some cases, the plurality of boreholes 310 are disposed along the length and width of the first leg member 220 and the second leg member 230 and are be spaced apart from one another so as to form at least one line of boreholes. As can be seen, in some cases there are at least three parallel lines of boreholes. As may also be appreciated from the figures, a plurality of boreholes 310 of each line (or portions thereof) can be equidistantly spaced apart from one another at a first interval in a first direction, and a second interval in a second direction. In some cases, the first and second intervals can be the same as one another or different from one another. For example, the distance between each borehole 310 in the length direction of second leg 230 may be set at 1.5 inches, whereas the distance between boreholes 310 in the width direction of the second leg 230 may be set at 1 inch. As may be appreciated, other distances may be utilized.

In the case of a plurality of lines of boreholes 310 where each borehole 310 is equidistantly spaced apart, a plurality of boreholes forming a first line of boreholes and a plurality of boreholes forming a second line of boreholes may be aligned with one another (as shown in the figures), or offset relative to one another (not shown).

Furthermore, while not shown in the figures, a length of second leg 230 and a length between one or more sets or pairs of lines of boreholes (disposed in the first direction) can be such that anchoring plates 210 can be directly simultaneously secured to at least two roof support structures such as rafters, trusses or joists, etc., as well as to the roof decking itself. In other words, a first line of boreholes on a first side of second leg 230 in the first direction may be used to directly secure the second leg 230 to a first rafter, and a second line of boreholes on an opposite second side of second leg 230 in the first direction may be used to simultaneously directly secure the second leg 230 to a second rafter. Additionally, while boreholes have been described as being equidistantly spaced apart and the like, the boreholes may be otherwise disposed relative to one another. That is, as the spacing between rafters may vary, boreholes 310 can be spaced apart so as to accommodate various known distances between rafters, e.g., rafter distances of 16 and/or 20 inches. In addition, anchoring plates 210 may be provided with appropriate markings (not shown) indicating the distance between various lines or pairs of boreholes, which lines or pairs of boreholes correspond to known rafter distances, e.g., 16 inches or 20 inches, which allows a user to readily identify which lines or pairs of boreholes can be utilized in order to secure the anchoring bracket to the one or more rafters, trusses, or joists, etc. Furthermore, the length of second leg 230 can be such that it spans known rafter distances, e.g., 16 and 20 inches, and also includes a first set or pair of boreholes disposed at a known rafter distance, e.g., 16 inches or 20 inches, as well as a second set or pair of boreholes adjacent to the first set that is also disposed at a known rafter distance, e.g., 16 inches or 20 inches, which allows the anchoring bracket to be readily shifted in the second direction, for example, if there is an obstruction that prevents one set or pair of boreholes to be utilized.

Also, while it is not shown in the figures, in some cases each of the anchoring brackets 210 can include third and/or fourth leg members similar to the first leg member (but not including a hinge knuckle) that extend in the first direction such that the first leg member and/or the third and/or fourth leg members intersect with the second leg member 220. In cases including third and/or fourth leg members, such members can include a plurality of boreholes disposed along a portion of a length or width thereof to form at least one line of boreholes. Additionally, the lines of boreholes of the third and/or fourth leg members can be spaced at known distances between roof support members such as rafters, trusses or joists, etc. and at distances of, for example, 16 inches or 20 inches, such that they may be directly secured to such support members using additional fasteners as may be required by local requirements, OSHA requirements, or ANSI standards.

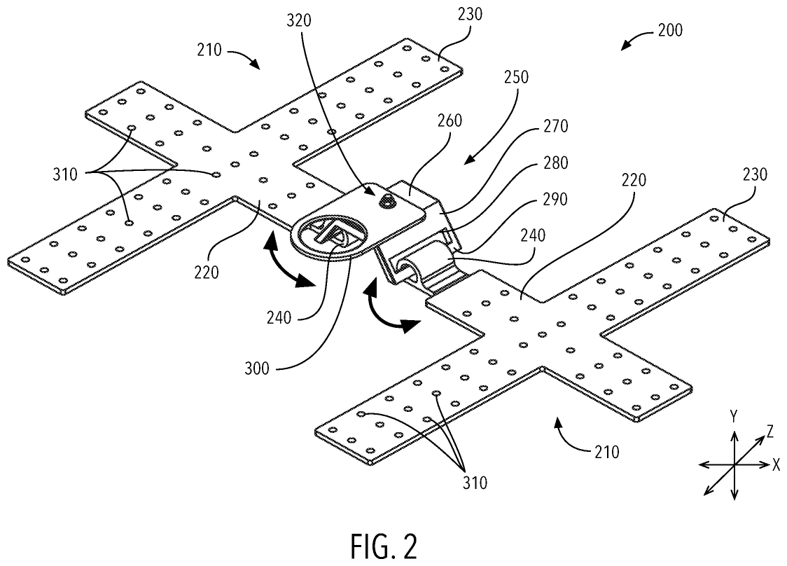

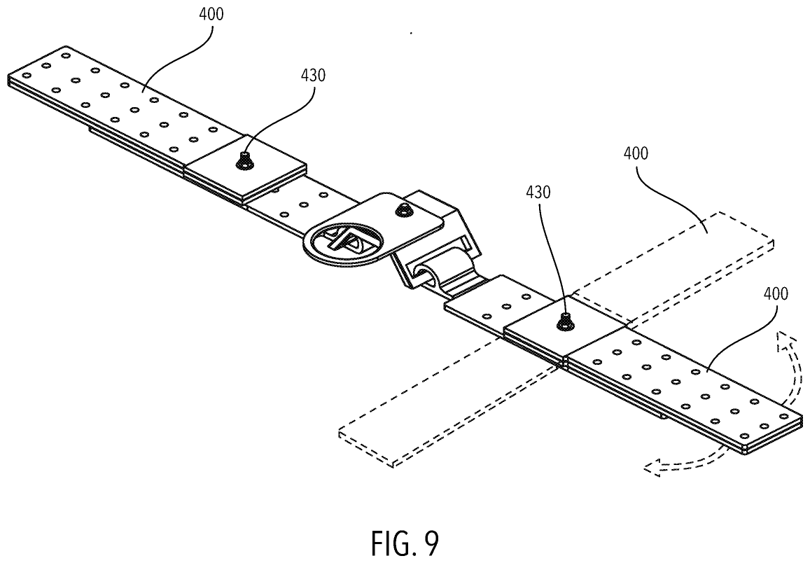

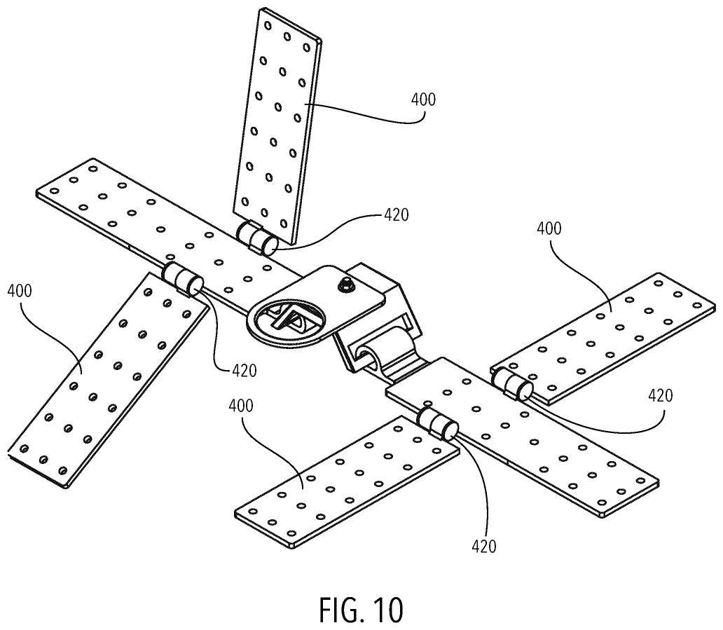

Referring to FIGS. 2, 9, and 10, one or more of the first leg member 220 and second leg member 230 (or other leg members) can be configured to be integrally connected to one another as shown in FIG. 2, or hingedly or rotatably connected as shown in FIGS. 9 and 10, respectively, to allow anchoring bracket 200 to be adjusted for purposes of being alternatively secured to another structure, or broken down for storage purposes, for example. As shown in FIG. 9, for example, second leg member 230 can be formed from a plurality of second leg sub-members 400 rotatably attached to first leg member 220 via a fastener assembly 430 including, for example, one or more of a bolt, a nut, one or more washers, bearing washers, or rivets, which allow the second leg sub-members 400 to rotate relative to one another as well as rotate relative to the first leg member 220. Similarly, while not shown, first leg member 220 can be rotatably connected to second leg member 230, without using separate second leg sub-members 400.

In the case of hinged attachment, as shown in FIG. 10, second leg member 230 can be formed from a plurality of second leg sub-members 400 hingedly attached to first leg member 220 via hinges 420, which allow each sub-member 400 to pivot relative to first leg member 220.

As previously set forth, anchoring plates 210 can be fabricated from appropriate materials in accordance with local regulations, OSHA regulations or ANSI standards and can comprise materials such as various types of steel, e.g., low carbon, stainless steel, chromoly steel, as well as other metals such as aluminum.

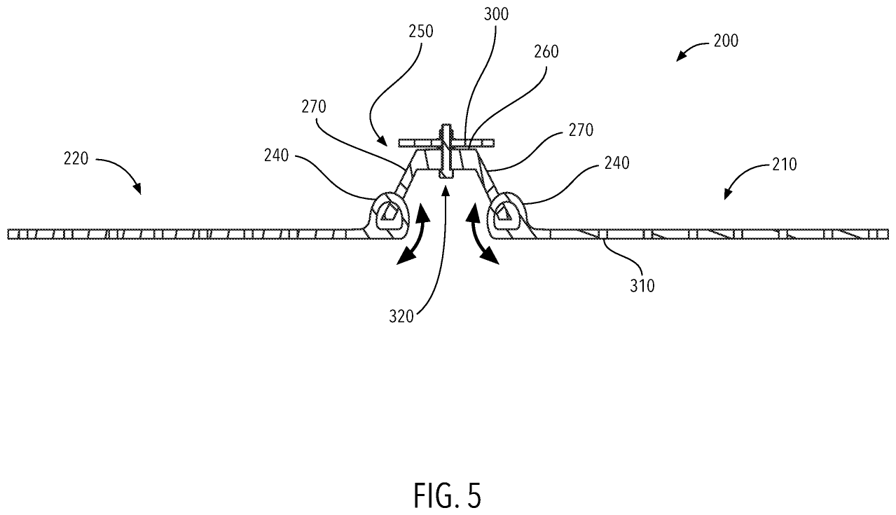

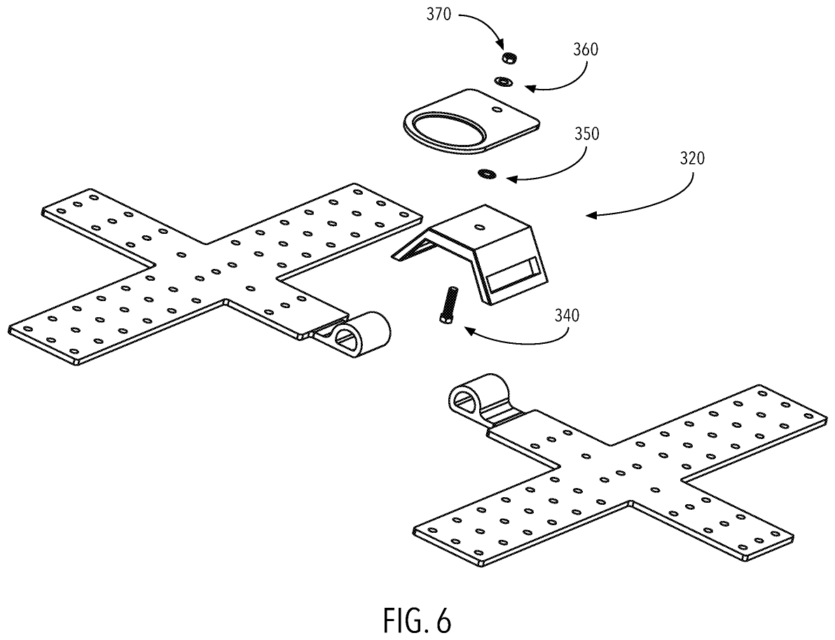

Referring now to FIGS. 2, and 5-8, ridge cap member 250 is provided for hingedly connecting each of anchoring plates 210 such that anchoring bracket 200 may adjusted so as to be secured to a surface such as a flat roof, or to peaked roof 500 as shown in FIG. 7. As shown in FIGS. 2 and 6, ridge cap member 250 includes top member 260 that connects a pair of opposite side members 270 that are disposed at opposite angles relative to the top member 260 so as to form a peak, which can be placed over the peak of a roof, for example. Each of oppositely disposed side members 270 include an aperture 280 that form a hinge pin member 290 that connects to hinge knuckle 240 of a respective first leg member 220 to thereby pivotally secure each anchoring plate 210 to the ridge cap member 250 on a respective opposite side of the ridge cap member. As shown in FIGS. 5 and 6, D-ring connector 300 is rotatably fastened to top side member 260 of the ridge cap member 250 by means of fastener/bearing assembly 320 and is configured for rotation relative to top side member 260. Fastener/bearing assembly 320 can be formed from one or more of bolt 340, bearing washer/thrust washer 350, washer 360, and nut 370 in accordance with local regulations, OSHA regulations and/or ANSI standards. Ridge cap member 250 can be fabricated from appropriate materials in accordance with local regulations, OSHA regulations or ANSI standards and can comprise materials such as various types of steel, e.g., low carbon, stainless steel, chromoly steel, as well as other metals such as aluminum. D-ring connector 300 can be fabricated from appropriate materials in accordance with local regulations, OSHA regulations or ANSI standards and can comprise materials such as various types of steel, e.g., low carbon, stainless steel, chromoly steel, as well as other metals such as aluminum. D-ring connector 300 can also be fabricated to include one or more force dampening/absorbing structures, or used in association with one or more force dampening/absorbing structures, as described in U.S. patent application Ser. No. 17/185,071, filed Feb. 25, 2021, which application is incorporated herein by reference.

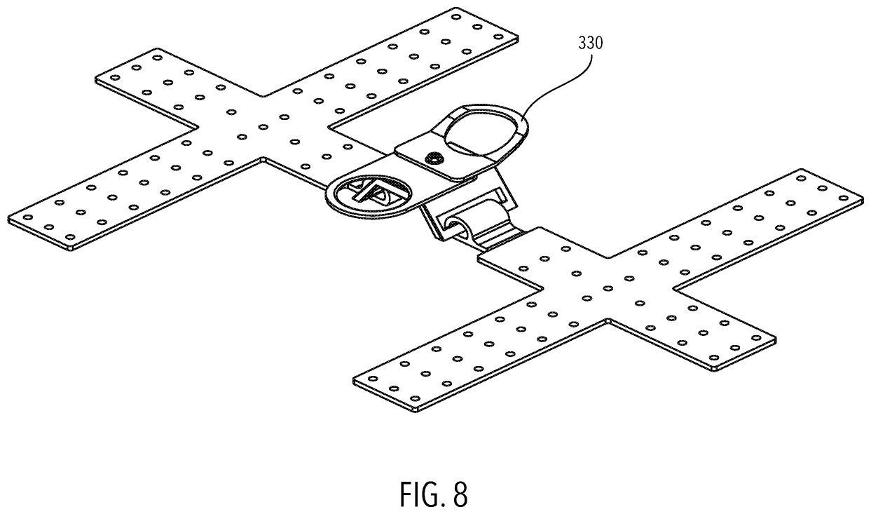

As shown more clearly in FIGS. 6 and 8, anchoring bracket 200 can include a plurality of D-ring connectors each rotatably connected to top side member 260 with one or more of a nut, a bolt, a washer, a bearing, a washer bearing, and a rivet such that they are rotatable relative to one another and rotatable relative to the top side member 260 of the ridge cap member 250. While FIG. 8 illustrates D-ring connector 300 and bent D-ring connector 330 as being coaxially rotatably secured to top side member 260 via a single fastener/bearing assembly, D-ring connector 300 and bent D-ring connector may be separately rotatably secured thereto. Also, as may be appreciated, in the case where a plurality of D-rings may be utilized and coaxially secured to top side member 260, as shown in FIG. 8, bent D-ring connector 330 can be utilized. Bent D-ring connector 330 includes a raised bent portion that elevates the connecting loop portion thereof relative to a base portion such that the connecting loop portion is separated from the connecting loop of D-ring 300. Thus, safety lines separately secured to each of D-ring connector 300 and bent D-ring connector 330 are less likely to tangle. Additionally, while not shown, in some situations, one or more stops or abutments can be included to limit the rotational range of the respective D-ring connection members 300/330 relative to one another and/or relative to top side member 260.

As shown in FIG. 7, anchor bracket 200 can be secured to a flat or peaked roof 500. In the case of peaked roof 500, ridge cap member 250 can be placed over peak 520 of the roof, and each anchoring bracket 210 allowed to rest atop opposite sides 500 of the roof. In cases where anchoring bracket 200 is to be secured to a single rafter, truss or joist, the middle line of boreholes 310 that extend along the longitudinal length (1^{st} direction) of first leg member 220 can be aligned with the rafter, truss or joist and secured thereto by means of appropriate fasteners in accordance with local regulations, OSHA regulations, and/or ANSI standards. Other securing strategies can also be employed. In cases where anchoring bracket 200 is to be secured to a plurality of rafters, trusses or joists, first and second lines of boreholes 310 that extend along the width of second leg member 230 (1^{st} direction), which are spaced apart at requisite distances between the rafters, joists or trusses, e.g. 16 or 20 inches, can be aligned such that the first line of boreholes is associated with a first rafter and the second line of boreholes is associated with a second rafter. Then, the aligned first and second lines of boreholes can be used, along with appropriate fasteners in accordance with local regulations, OSHA regulations, and/or ANSI standards to secure the anchoring bracket to the aligned first and second rafter, trusses or joists. In both cases, e.g., securing to a single rafter or a plurality of rafters, additional unused boreholes may be used along with fasteners to further secure the anchoring bracket directly to the deck structure of the roof. Finally, as may be further appreciated from FIG. 7, because D-ring connector 300 of the anchoring assembly is able to rotate relative to the ridge cap member 250, the incidence of swing falls can be vastly reduced and the effective working range of anchoring bracket 200 may be increased beyond the limits associated with anchor bracket 100 as shown in FIGS. 1A and 1B.

Thus, it is seen that the objects of the present disclosure and inventions described herein are efficiently obtained, although modifications and changes to the inventions should be readily apparent to those having ordinary skill in the art, which modifications are intended to be within the spirit and scope of the inventions as claimed. It also is understood that the foregoing description is illustrative of the inventions and should not be considered as limiting. Therefore, other aspect and embodiments of the inventions are possible without departing from the spirit and scope of the inventions.

### Parts List

100 Known Anchoring Bracket
110 Base Member
120 Leg
130 Knuckle
140 Hinge Pin/D-ring
150 Throughbore
200 Anchoring Bracket
210 Anchoring Plate
220 First Leg Member
230 Second Leg Member
240 Hinge Knuckle
250 Ridge Cap Member
260 Top Side Member
270 Opposite Side Members
280 Aperture
290 Hinge Pin Member
300 D-ring connector
310 Boreholes
320 Fastener/Bearing Assembly
330 Bent D-ring
340 Bolt
350 Bearing Washer/Thrust Washer
360 Washer
370 Nut
400 Second Leg Sub Member
420 Hinge
430 Fastener/Bearing Assembly
500 Peaked Roof
510 Roof Side
520 Roof Peak

What is claimed is:

1. An anchoring bracket (200), comprising:
a pair of anchoring plates (210), each including at least a first leg member (220) extending in a first direction and at least a second leg member (230) extending in a second direction perpendicular to the first direction such that the first leg member (220) and the second leg member (230) intersect with one another, each of the at least one first leg member (220) including a hinge knuckle (240) at a terminal end thereof;
a ridge cap member (250) including a top member (260) connecting a pair of opposite side members (270) disposed at opposite angles to thereby form a peak, each of the oppositely disposed side members (270) including an aperture (280) forming a hinge pin member (290) that connects the hinge knuckle (240) of a respective first leg member (220) such that each of the pair of anchoring plates (210) is pivotally secured to the ridge cap member (250) on a respective opposite side member (270) of the ridge cap member (250); and
a D-ring connector (300) rotatably connected to the top side member (260) of the ridge cap member (250).

2. The anchoring bracket of claim 1, wherein each of the first leg member and second leg member include at least a plurality of spaced apart boreholes (310) disposed along a portion of a length or width of each of the first leg member and the second leg member.

3. The anchoring bracket of claim 2, wherein the plurality of boreholes disposed along a portion of the length or width of the first leg member and the second leg member are spaced apart from one another to form at least one line of boreholes.

4. The anchoring bracket of claim 3, wherein the plurality of boreholes disposed along a portion of the length or width of the first leg member and the second leg member are spaced apart from one another to form at least two lines of boreholes.

5. The anchoring bracket of claim 3, wherein the plurality of boreholes disposed along a portion of the length or width of the first leg member and the second leg member are spaced apart from one another to form at least three lines of boreholes.

6. The anchoring bracket of claim 3, wherein a portion of the plurality of boreholes forming the at least one line of boreholes are equidistantly spaced apart from one another.

7. The anchoring bracket of claim 6, wherein a first portion of the plurality of boreholes forming the at least one line of boreholes are equidistantly spaced apart from one another, and a second portion of the plurality of boreholes forming the at least one line of boreholes are not equidistantly spaced part from one another.

8. The anchoring bracket of claim 4, wherein the plurality of boreholes form at a first line of boreholes and a second line of boreholes, and wherein a portion of the plurality of boreholes of the first line are equidistantly spaced apart from one another, and a portion of the plurality of boreholes of the second line are equidistantly spaced apart from one another, and the portion of the line of boreholes associated with the first line are aligned relative to the portion of the line of boreholes associated with the second line along one of a length or width thereof.

9. The anchoring bracket of claim 4, wherein the plurality of boreholes form at least a first line of boreholes and a second line of boreholes, and wherein a portion of the plurality of boreholes of the first line are equidistantly spaced apart from one another, and a portion of the plurality of boreholes of the second line are equidistantly spaced apart from one another, and the portion of the line of boreholes associated with the first line are offset relative to the portion of the line of boreholes associated with the second line along one of a length or width thereof.

10. The anchoring bracket of claim 1, wherein each of the anchoring plates includes a third leg member extending in a second direction perpendicular to the first direction such that the first leg member and the third leg member intersect with one another, the third leg member including a plurality of boreholes disposed along a portion of a length or width thereof to form at least one line of boreholes.

11. The anchoring bracket of claim 1, wherein the second leg member of each anchoring plate is integral with the first leg member of each anchoring plate.

12. The anchoring bracket of claim 1, wherein the second leg member of each anchoring plate comprises a pair of second leg sub-members hingedly connected to the first leg member on opposite sides thereof.

13. The anchoring bracket of claim 1, wherein the second leg member of each anchoring plate comprises a pair of second leg sub-members rotatably connected to the first leg member.

14. The anchoring bracket of claim 1, wherein the second leg member of each anchoring plate is rotatably connected to the first leg member.

15. The anchoring bracket of claim 1, wherein the top side member of the ridge cap member is disposed at a height relative to each of the apertures, and the D-ring connector is rotatably connected to the top side member with one or more of a nut, a bolt, a washer, a bearing, a washer bearing, and a rivet.

16. The anchoring bracket of claim 1, comprising a plurality of D-ring connectors, each of the D-ring connectors rotatable relative to the top side member and rotatable relative to one another.

17. The anchoring bracket of claim 16, wherein the top side member of the ridge cap member is disposed at a height relative to each of the apertures, and each of the plurality of the D-ring connectors are coaxially rotatably connected to the top side member with one or more of a nut, a bolt, a washer, a bearing, a washer bearing, and a rivet.

18. The anchoring bracket of claim 17, wherein one of the plurality of D-ring members includes a flat top side member connecting portion and a raised bent portion, the raised bent portion being offset at a height relative to the flat top side member connecting portion.

19. The anchoring bracket of claim 18, wherein at least one or more of a washer or bearing is disposed between the plurality of D-ring members.
